(19) United States
(12) Patent Application Publication
(10) Pub. No.: US 2007/0214043 A1
(43) Pub. Date: Sep. 13, 2007

(54) Advertisement providing service control system

(75) Inventor: Takashi Yasuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/472,988

(22) Filed: Jun. 23, 2006

(30) Foreign Application Priority Data
Mar. 8, 2006 (JP) JP2006-062546

(51) Int. Cl. G06Q 30/00

(52) U.S. Cl. 705/14

(57) ABSTRACT

An advertisement providing service control device operated by a mobile carrier, has means receiving, from a mobile communication terminal utilized by a user, an encrypted advertisement code corresponding to two-dimensional code acquired from a two-dimensional code attached advertisement provided by a sponsor enterprise, means judging validity of the received encrypted advertisement code by collating with storage information, and means calculating, when the encrypted advertisement code is valid, an amount of money equivalent to a discount for the user in accordance with an advertisement acquisition count, and calculating a service fee for the sponsor enterprise. Herein, the encrypted advertisement code contains sponsor enterprise identification information, advertisement commercial article identification information and advertising medium identification information in a copy-disabled mode.

### BACKGROUND OF THE INVENTION

The present invention relates to an advertisement providing service control system enabling a higher publicity effect to be obtained by linking up with a sponsor enterprise of an advertisement and a mobile carrier such as a mobile phone network operator.

Over the recent years, with lower prices and higher performance of TV (television) program recording devices such as hard disc recorders, there has been a remarkable decline of a publicity effect of a TV broadcasting advertisement (commercial) (TV-CM). A reason why so is that the TV-CM inserted in a program is not viewed by users in many cases due to utilizing a function of recoding in a way that skips the TV-CM or a fast-forwarding function when reproduced, and so on.

Further, as for a printed advertisement such as a magazine, an advertisement page can be easily skipped in reading, and a sufficient publicity effect cannot be obtained.

Given as a general method of enhancing the publicity effect is a mechanism of providing a reward that can be applied by only persons seeing the advertisement and persons purchasing a commercial article, however, this mechanism has the following problems and can not be said to be widely utilized.

(1) Individual information such as an address is easy to be caught by eyes of a third party like the sponsor enterprise as a sponsorship party, and this problem is serious in terms of protecting the individual information.

(2) Generally, the persons receiving a special benefit are only applicants chosen by lottery in many cases, and hence the great majority of users are unable to receive the special benefit. As a result, the effect of the advertisement attached with the reward is exhibited to only the users of concentrated strata (ages (generations) and distinction of sex).

(3) The application for the reward is made in many cases by mailing a postcard or by using the Internet, so that it is troublesome to the user entering (inputting) an address, a telephone number, etc.

The following are related arts to the present invention.
[Patent document 1] Japanese Patent Laid-Open Publication No. 2004-5745
[Patent document 2] Japanese Patent Application Laid-Open Publication No. 2002-111909

### SUMMARY OF THE INVENTION

It is an object of the present invention to provide a technology of giving a solution for a publicity effect enhancement scheme hitherto conducted only between an advertisement sponsor enterprise and a user through intervention of a mobile carrier such as a mobile phone network operator and enabling the publicity effect to be further enhanced.

In order to solve the problems given above, according to the present invention, an advertisement providing service control device operated by a mobile carrier, comprises means receiving, from a mobile communication terminal utilized by a user, an encrypted advertisement code corresponding to two-dimensional code acquired from a two-dimensional code attached advertisement provided by a sponsor enterprise, means judging validity of the received encrypted advertisement code by collating with storage information, and means calculating, when the encrypted advertisement code is valid, an amount of money equivalent to a discount for the user in accordance with an advertisement acquisition count, and calculating a service fee for the sponsor enterprise.

Herein, the encrypted advertisement code can contain sponsor enterprise identification information, advertisement commercial article identification information and advertising medium identification information in a copy-disabled mode. Further, the encrypted advertisement code can contain serial number information for every advertising medium in the copy-disabled mode.

Still further, the advertisement is at least one of a visible broadcasting advertisement, a visible distribution advertisement and a paper advertisement. Yet further, the two-dimensional code is of any one of a matrix system and a stacked bar code system.

The advertisement providing service control device according to the present invention may further comprise means providing the mobile communication terminal with software for reading and transmitting the two-dimensional code in response to a download request.

According to the present invention, the following effects can be expected.

(1) The user receives the special benefit without disclosing the individual information such as an address and a name to the sponsor enterprise, and hence the advertisement providing service capable of presenting the special benefit can be actualized without causing any leakage of the individual information.

(2) All the users establishing a contract with the mobile carrier can surely receive the special benefit.

(3) With an increase in chance of the user's utilizing the special benefit owing to the effects (1) and (2), it is possible to enhance the publicity effect of the advertisement of the sponsor enterprise.

(4) Costs (such as adding up the applicants, conducting the lottery, and delivering a prize) required so far other than for the special benefit itself are narrowed down to only a service fee to the mobile carrier, and the sponsor enterprise is thereby capable of reducing the costs.

(5) The mobile carrier can acquire a profit with the service fee from the sponsor enterprise with small investment in a way diverts the existing call charge discount method.

Other objects, features and advantages of the present invention will become apparent by reading the specification (an embodiment) that will hereinafter be described when taken in conjunction with the drawings and scope of claims appended.

### BRIEF DESCRIPTION OF THE DRAWINGS

FIG. 1 is a block diagram showing architecture of an advertisement providing service control system in one embodiment of the present invention;

FIG. 2 is an explanatory diagram showing a business model in the advertisement providing service control system;

FIG. 3 is an explanatory diagram showing a service utilizing contract established between a user and a mobile phone network operator;

FIG. 4 is an explanatory diagram showing a service utilizing contract established between the mobile phone network operator and a sponsor enterprise;

FIG. 5 is a diagram showing a structure of a sponsor enterprise advertisement information database;

FIG. 6 is a diagram showing advertisement code generating procedures;

FIG. 7 is a diagram showing procedures of attaching a special benefit QR code to an advertisement;

FIG. 8 is an explanatory diagram showing an operation of application software for transmitting special benefit advertisement code information;

FIG. 9 is an explanatory diagram showing how the special benefit QR code information is received and collated;

FIG. 10 is a diagram showing an outline of a discount point calculation process per month;

FIG. 11 is a diagram showing a discount point calculation processing procedure per month;

FIG. 12 is a diagram showing an outline of calculating a sponsor enterprise's share of expenses; and

FIG. 13 is a diagram showing a processing procedure of calculating the sponsor enterprise's share of expenses.

### DETAILED DESCRIPTION OF THE PREFERRED EMBODIMENTS

The present invention will hereinafter be described in greater detail with reference to the accompanying drawings. The drawings illustrate a preferred embodiment of the present invention. The present invention can be, however, carried out in many different modes and should not be construed to be limited to the embodiment described in the specification. More essentially, the embodiment is provided so that the disclosure of the specification becomes thorough and perfect, and so that the scope of the present invention is sufficiently conveyed to those skilled in the art.

System Architecture

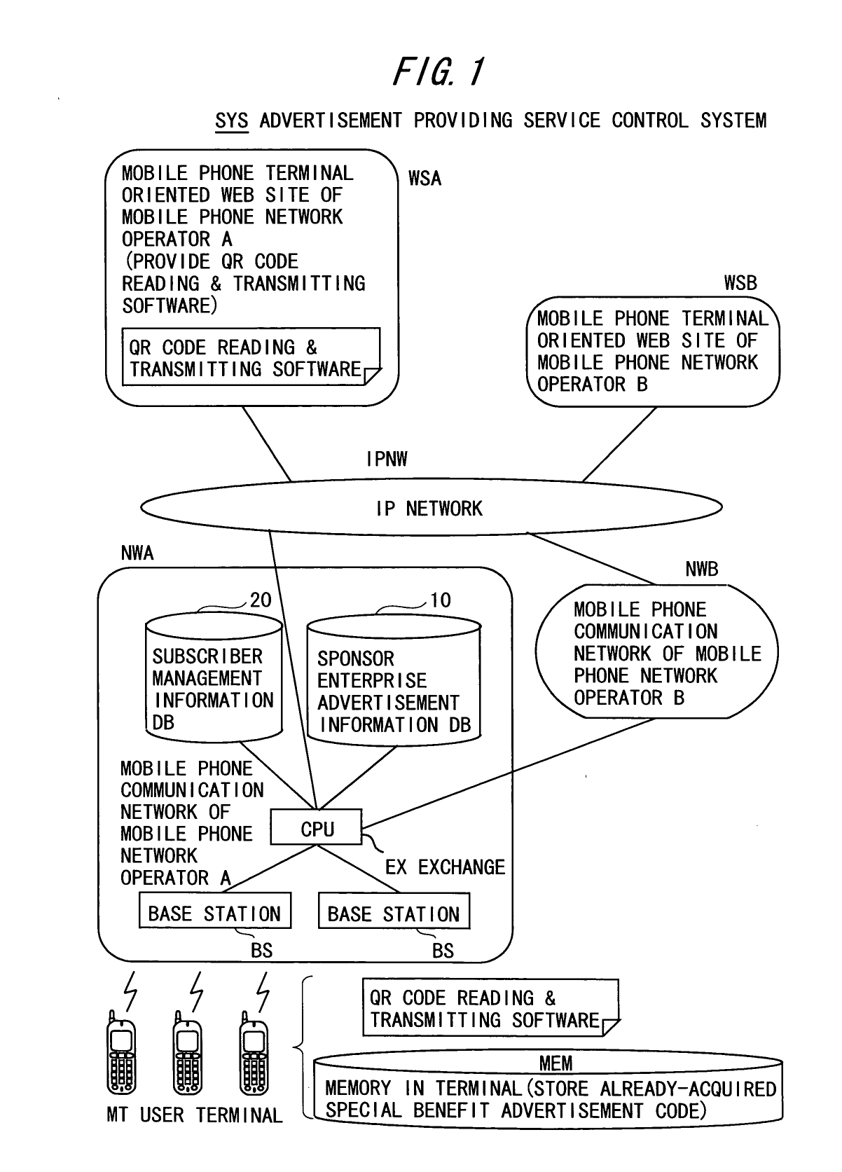

Referring to FIG. 1 showing an architecture of a system in one embodiment of the present invention, an advertisement providing service control system SYS includes mobile phone communication networks NWA, NWB as mobile operator's networks administered respectively by mobile phone network operators A, B defined as mobile network operators (mobile carriers), and an IP (Internet Protocol) network IPNW such as the Internet.

The mobile phone communication network NWA includes a base station BS, abase station control device (not shown), an exchange EX, a subscriber management information database (DB) 20 and a sponsor enterprise advertisement information database (DB) 10. Through an illustration of a detailed configuration is omitted, mobile phone communication network NWB has the same configuration as the mobile phone communication network NWA has. The exchanges EX in the mobile phone communication networks NWA, NWB are connected to each other and are connected via communication lines to the IP network IPNW.

The IP network IPNW includes Web sites WSA, WSB oriented for the mobile phone terminals. The Web sites WSA, WSB oriented for the mobile phone terminals correspond to the mobile phone network operators A, B and are built up on server computers.

A user terminal (mobile phone terminal) MT serving as a mobile communication terminal utilized by a user (subscriber) has an image capturing (imaging) function in addition to a communication function, an information retaining function, etc. It is to be noted that the user terminal MT may be any one of a single-unit body and a multi-unit body as exemplified by a mobile information terminal on condition that the user terminal MT has the communication function, an information input function, an information display function, an information designation function, the information retaining function and the image capturing (imaging) function.

Though described in detail later on, in this advertisement providing service control system SYS, each of the server computers building up the Web sites WSA, WSB retains application software for reading and transmitting QR (Quick Response) code (registered trademark) that is a kind of matrix system of two-dimensional code (which might be simply referred to as QR software), and provides the QR software in response to a download request given from the user terminal MT.

Further, in this advertisement providing service control system SYS, among the components configuring the mobile phone communication networks NWA, NWB, each of the exchanges EX is provided with a central processing unit as a control device CPU to which a function of implementing an advertisement providing service (QR advertisement discount) is added. This control device CPU may be provided separately from the central processing unit having a general processing function in the mobile communications. The sponsor enterprise advertisement information database 10 is newly provided for implementing this advertisement providing service. The subscriber management information database 20 manages information for implementing the advertisement providing service in addition to a function of managing the general information (e.g., location information etc) in the mobile communications.

Business Model

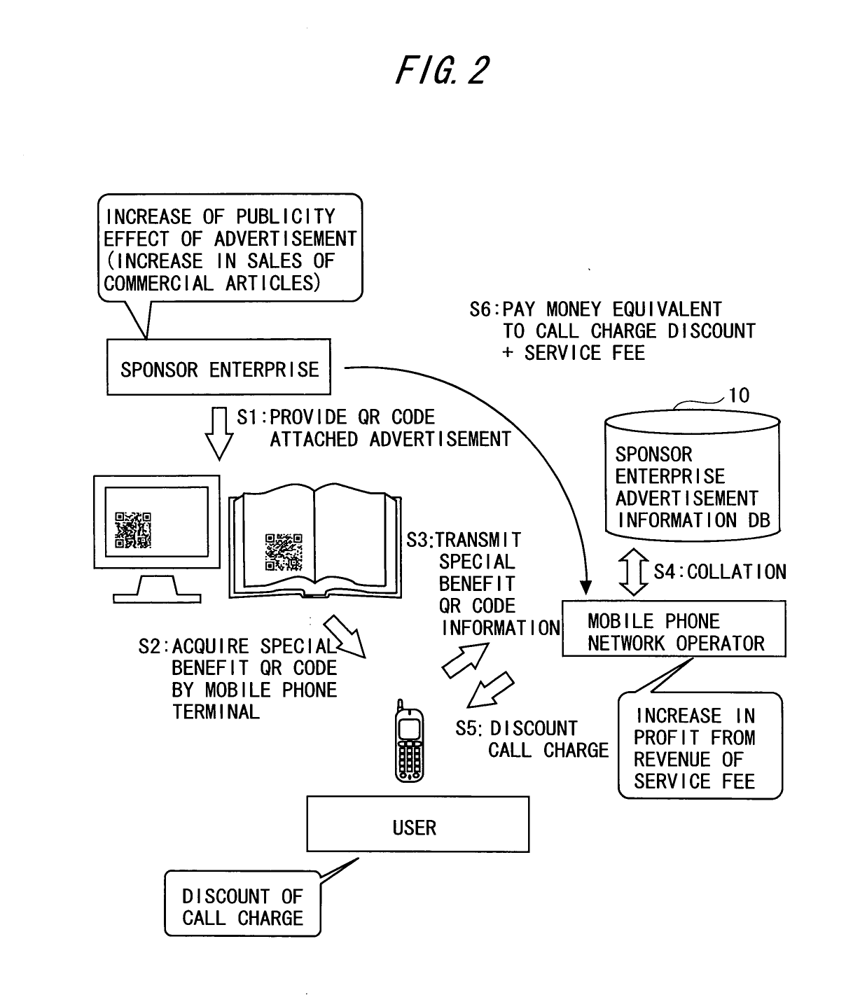

Next, a business mode carried out in the advertisement providing service control system SYS in one embodiment of the present invention shown in FIG. 1 will be explained with reference to FIG. 2.

FIG. 2 shows a relationship between three parties, i.e., a sponsor enterprise, the mobile phone network operator and the user.

The sponsor enterprise provides an advertisement attached with the QR code (registered trademark) (which might hereinafter be described as a QR-CD unless limited otherwise) in the form of a TV broadcasting advertisement (visible broadcasting advertisement), a visible distributing advertisement or a printed advertisement (paper advertisement) (S1). The user captures an image of the QR-CD by the mobile phone terminal MT and thus acquires the QR-CD (S2); and the user transmits QR-CD information (data) to the mobile phone network operator (S3).

The mobile phone network operator checks validity of the received data (S4), and, if valid, discounts a call charge etc corresponding to a quantity of the QR-CD acquired by the user (S5). The sponsor enterprise is charged with an amount of money equivalent to the discount of the call charge and a service fee for the mobile phone network operator (S6).

The problems described above are solved by configuring the business model in the way given below.

(1) The mobile phone network operator previously grasps the individual information of the user, and therefore the user has no necessity of submitting the information. Hence, the individual information is not exposed to the third party including the sponsor enterprise.

(2) All the users employing the mobile phone terminals can receive special benefits, resulting in an increase in the number of users who see the advertisement.

(3) To the user, an extremely simple operation of reading the QR-CD may suffice.

(4) Further, it is expected that a publicity effect of the advertisement provided by the sponsor enterprise be improved owing to a multiplier effect thereof.

Outline of Operation

Next, an outline of the operation in the advertisement providing service control system SYS in one embodiment of the present invention, will be described with reference to FIGS. 1 and 2 in combination.

A (precondition): A contract about the discount of the call charge corresponding to an advertisement viewership quantity (advertisement acquiring count) is agreed upon between the user and the mobile phone network operator.

B (precondition) : A contract about the sponsor enterprise being charged with the amount of money equivalent to the discount of the call charge receivable by the user in accordance with the advertisement viewership quantity and charged with the service fee, is agreed upon between the mobile phone network operator and the sponsor enterprise. At this time, the sponsor enterprise provides the QR-CD information to the mobile phone network operator, and the mobile phone network operator retains the QR-CD information in the sponsor enterprise advertisement information DB 10.

C: The sponsor enterprise provides the advertisement attached with the QR-CD via the TV broadcasting or the paper space of a magazine, etc. The QR-CD contains enterprise identification information, commercial article identification information, advertising medium identification information and serial number information of the advertising medium while encrypting these items of information in a copy-disabled status.

D: The user captures the image of the QR-CD of the advertisement by use of the mobile phone terminal MT having a built-in camera. At this time, it follows that the user invariably sees the advertisement, and consequently an appetite for purchasing the commercial article of that enterprise is more or less strengthened.

E: The user terminal MT automatically transmits the data in the imaged QR-CD in an as-encrypted state to the mobile phone network operator (herein, the mobile phone communication network NWA).

F: The mobile phone network operator (herein, the control device CPU of the exchange EX configuring the mobile phone communication network NWA) collates the received data with contents of the sponsor enterprise advertisement information DB 10 and, if being the proper (valid) data issued by the sponsor enterprise establishing the contract shown in the Item B, adds a discount point for the user concerned.

G: The mobile phone network operator (the control device CPU of the exchange EX) processes so as to discount the call charge for the user in accordance with the discount point when calculating the call charge per month.

H: The mobile phone network operator processes so as to receive from the sponsor enterprise an amount calculated by adding the service fee to the discounted call charge.

Owing to this operation, the following respective merits occur among the three parties. Namely, the user receives the discount of the call charge etc. The mobile phone network operator gains an increase in profit from revenue of the service fee out of the sponsor enterprise. The sponsor enterprise has an increased effect of the publicity of the advertisement, which leads to sales promotion of the commercial article.

Specific Example of Operation

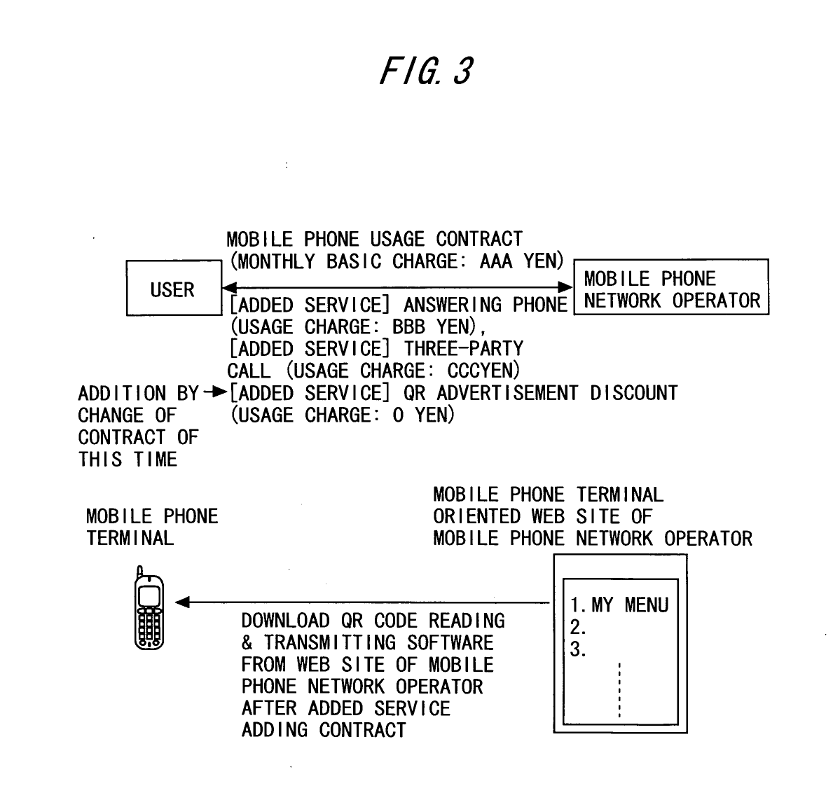

Next, a specific example of the operation in the advertisement providing service control system SYS in one embodiment of the present invention will hereinafter be described with reference to FIGS. 1 and 2 and the related drawings (FIGS. 3 through 13) in combination. Note that in the description of the operation exemplified as below, unless limited otherwise, the intermediary of the IP network IPNW is omitted.

A: Service Using Contract between User and Mobile Phone Network Operator (see FIG. 3)

A contract about utilizing the advertisement providing service (the discount of the QR advertisement) as an additional service is agreed upon between the user (the user terminal MT) and the mobile phone network operator (e.g., the server computer building up the Web site WSA). Based on this contract, the mobile phone network operator (the control device CPU of the exchange EX) discounts the call charge (adds a discount point) in accordance with the advertisement viewership count of the user.

Further, after establishing the contract of the present additional service, the user downloads, into the user terminal MT, the application software (the QR software) for the user terminal MT in order to perform reading and transmitting the QR-CD information from the Web site WSA of the mobile phone network operator A. The QR software is stored in a memory MEM within the user terminal MT and can be started up any time by a key operation.

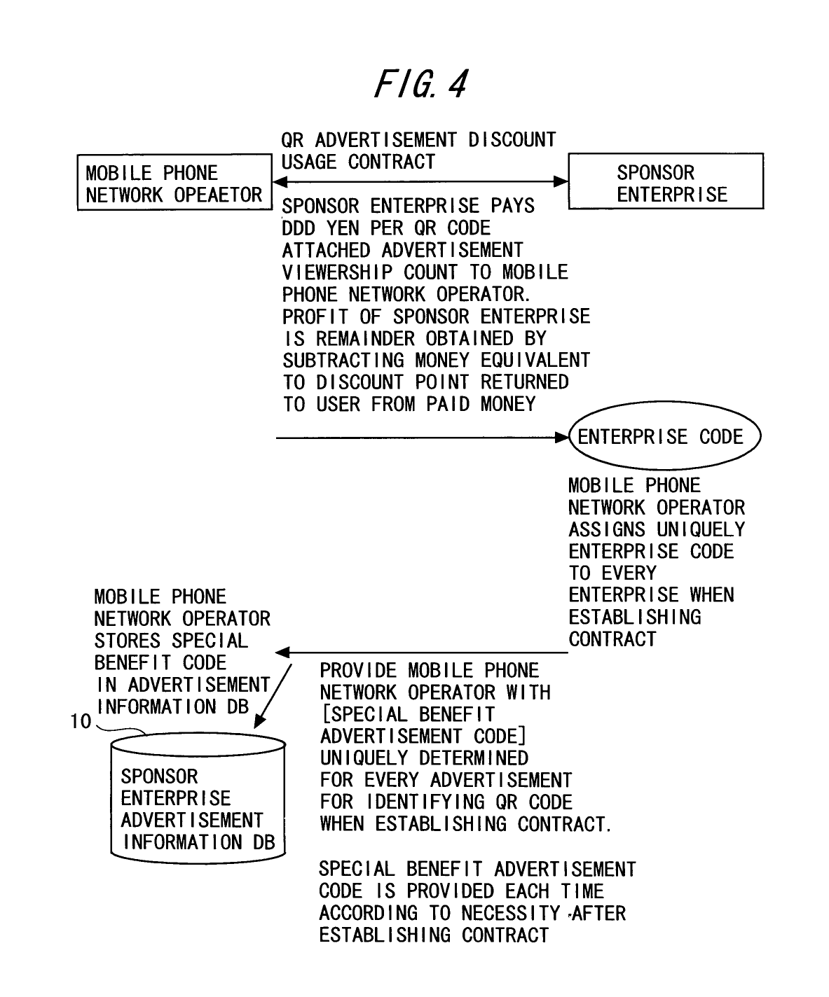

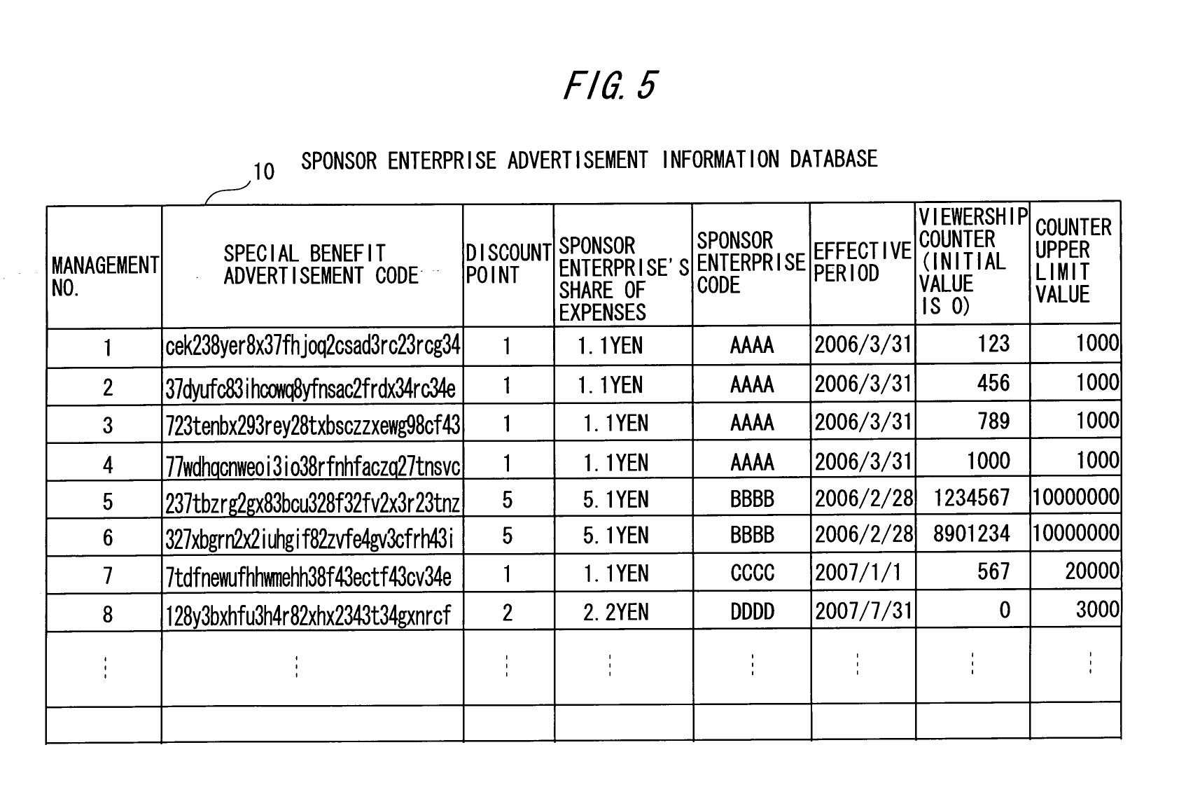

B: Service Utilizing Contract between Mobile Phone Network Operator and Sponsor Enterprise (see FIGS. 4 and 5)

The sponsor enterprise establishes online or offline a contract that a fixed amount of money shall be paid to the mobile phone network operator in accordance with the viewership count of the advertisement of this sponsor enterprise. Based on this contract, the mobile phone network operator gains a profit that is an amount of money acquired by subtracting the amount of money equivalent to the discount point returned to the user from the amount of money received from the sponsor enterprise. Further, simultaneously with the contract, the mobile phone network operator (the control device CPU) attaches and provides the enterprise code to the sponsor enterprise. The sponsor enterprise determines a special benefit advertisement code attached to the advertisement of the self-company commercial article by a method described in the following item C, and provides this special benefit advertisement code to the mobile phone network operator. The special benefit advertisement code is managed on the sponsor enterprise advertisement information DB 10 allocated in the mobile phone communication network NWA of the mobile phone network operator A.

The sponsor enterprise advertisement information DB 10 has a structure as shown in FIG. 5. In the case of receiving a new special benefit advertisement code from the sponsor enterprise, the received code is added to a free area in the sponsor enterprise advertisement information DB 10. As will be described in the following item F, when receiving the special benefit advertisement code from the user, “1” is added to a value of the viewership counter. Further, for preventing the addition from permanently continuing, an effective period and an upper limit value are provided, and no addition shall be made when reaching the effective period and the upper limit value.

On the other hand, user's motivation for viewing (the advertisement) changes depending on the discount amount finally received by the user, and hence competition arises among the plural sponsor enterprises. Further, the mobile phone network operator selected for utilizing the service by the sponsor enterprise changes depending on the amount of service fee of the mobile phone network operator, and therefore the competition also arises among the mobile phone network operators.

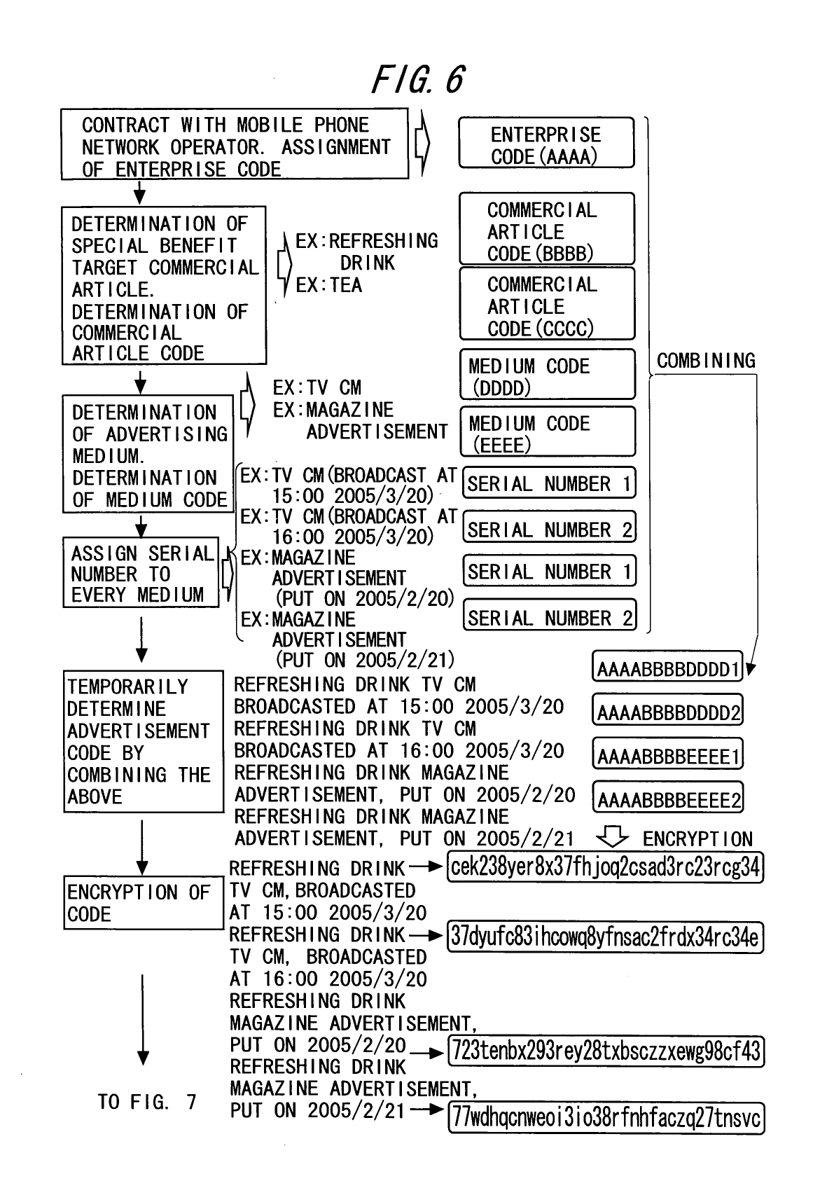

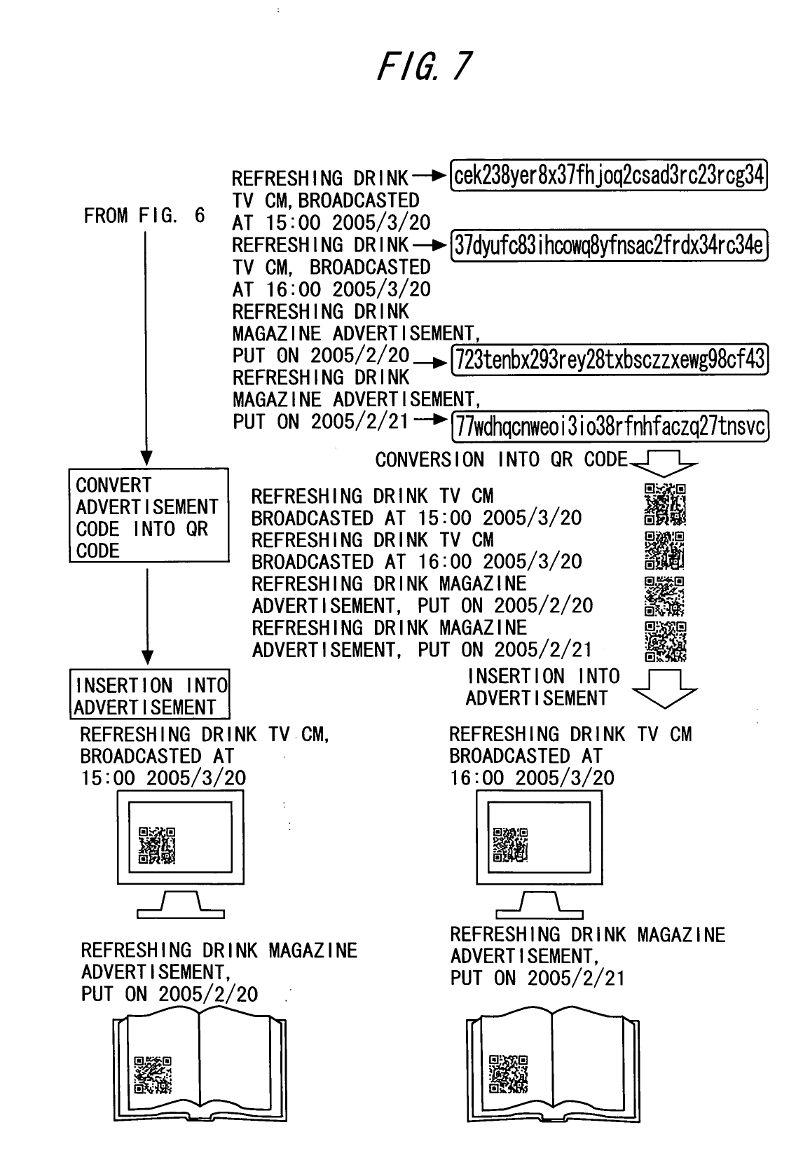

C: Sponsor Enterprise's Providing Advertisement Attached with Special benefit QR-CD (see FIGS. 6 and 7)

The sponsor enterprise attaches the special benefit QR-CD to the advertisement of the self-company. On this occasion, the special benefit QR-CD different according to the advertisement is attached, and hence the special benefit advertisement code is determined as follows.
Code example: aaabbbbccccddd
aaa: Enterprise code (unique for every enterprise)
bbb: Commercial article code (unique for every commercial article)
ccc: Advertising medium code (TV, Website, magazine, newspaper, hang-down advertisement in train, etc)
ddd: Serial number of every medium

For example, the codes shall be different for broadcasting even the same TV-CM at 15:00 and at 16:00. The codes for the same magazine advertisement shall be different in April issue and in May issue.

Moreover, on the occasion of setting the special benefit QR-CD, the special benefit advertisement code is encrypted into the copy-disabled information (the code unrecognizable to user) and thus attached to the advertisement. Note that the effective period of the special benefit QR-CD shall be attached simultaneously in order to prevent the use after the effective period to the greatest possible degree. Even if the user acquires the special benefit QR-CD after the effective period, the special benefit QR-CD is treated as the invalid QR-CD by the mobile phone network operator afterward, and hence no problem occurs (refer to the following item F for more details).

On the other hand, the special benefit advertisement code generated herein is managed in the as-encrypted state in the mobile phone network operator and is therefore not required to be decrypted (it is better to make the decryption difficult). Hence, it is effective to encrypt the special benefit advertisement code by use of Hash function defined as an irreversible one-way function as widely employed for checking a password of PPP (Point-to-Point Protocol) and so on.

D: User's Acquisition of Special benefit QR-CD

The user captures the image of the special benefit QR-CD of the advertisement of TV, the magazine, the newspaper, etc by the mobile phone terminal MT having the built-in camera. This operation is manually conducted by an intention of the user, and it therefore follows that the user inevitably focuses his or her eye on a content itself of the advertisement. The user's appetite for purchasing the commercial article is thereby strengthened, and the same effect as the conventional reward-attached advertisement has is obtained.

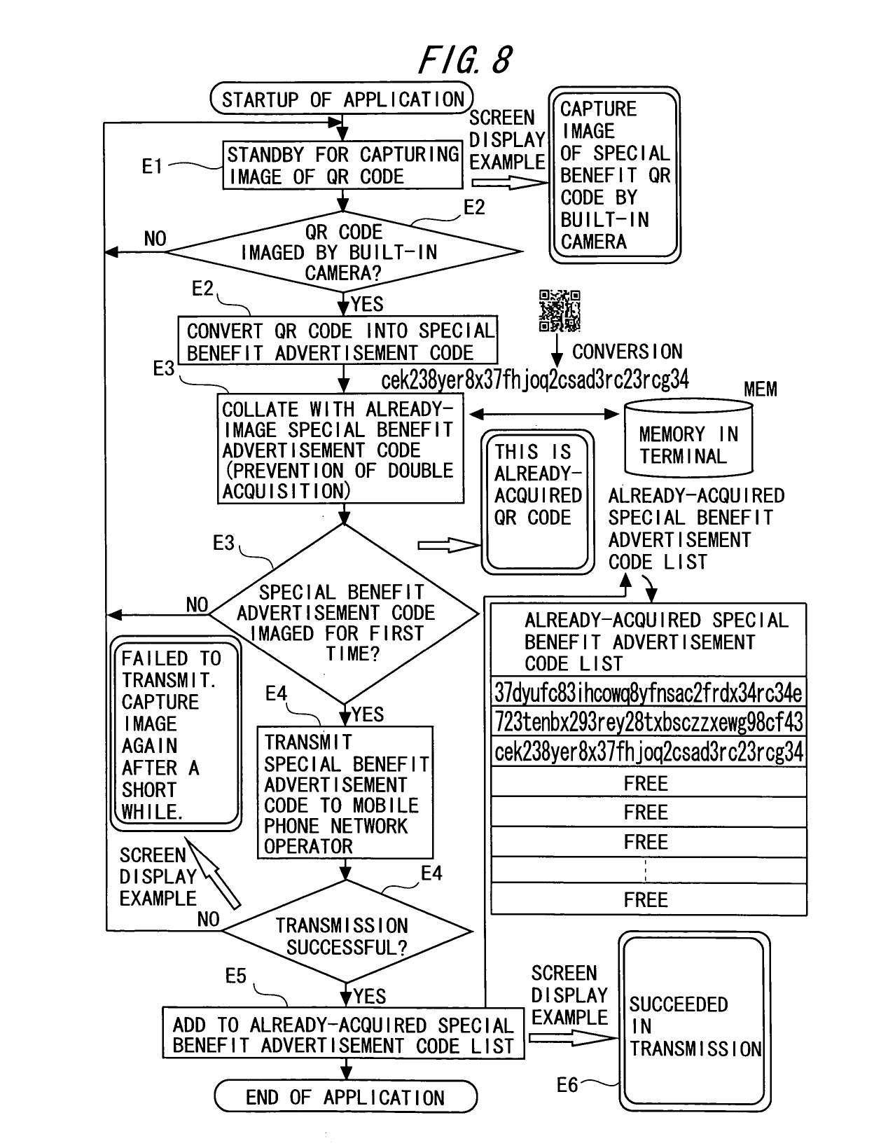

E: Transmission of Special benefit QR-CD Information (see FIG. 8)

Transmission of the acquired special benefit QR-CD information to the mobile phone network operator involves utilizing the QR software downloaded into the user terminal MT when establishing the service contract between the user and the mobile phone network operator. This QR software performs the following operations as shown in FIG. 8.

[E1] The QR software in the user terminal MT is started up by the key operation of the user, and the user terminal MT comes to a standby status for capturing the image of QR-CD.

[E2] When capturing the image of the QR-CD, the QR-CD information is converted into the special benefit advertisement code. This special benefit advertisement code is encrypted and is therefore an unrecognizable character string.

[E3] Whether the special benefit advertisement code has already been acquired or not is judged by referring to an [already-acquired special benefit advertisement code list] retained in the memory MEM within the user terminal MT. If already acquired, an error message showing this purport is displayed, and the operation returns to the standby status for capturing the image of the QR-CD described in the item [E1] given above.

[E4] In the case of the special benefit advertisement code acquired for the first time, a short message is transmitted to the mobile phone network operator (the control device CPU). If failing to transmit (a network congestion etc), an error message showing this purport is displayed, and the operation returns to the standby status for capturing the image of the QR-CD described in the item [E1] given above.

[E5] In the case of succeeding in the transmission, this code information is added to the last area of the [already-acquired special benefit advertisement code list] described in the item [E3] given above. On this occasion, if there is no free area, the codes are overwritten from the oldest in a way that gets back to the head code. If the user acquired many special benefit advertisement codes, through there is a possibility of reacquiring the old code overwritten in the past, however, the mobile phone network operator checks double acquisition, and hence there is no problem even if unable to detect the double acquisition on the side of the user terminal MT. The check herein is implemented for restraining the transmission of the unnecessary messages as much as possible.

[E6] Finally, a message purporting that the transmission gets successful is displayed, and the operation returns to the standby status for capturing the image of the QR-CD described in the item [E1] given above.

The user transmits the QR-CD from the user terminal MT in order to acquire the special benefit, however, the mobile phone network operator has already recognized the individual information such as an address, a name, etc of the user, so that the user has no necessity of giving the notification hereat. Namely, there is none of risk of leakage of the individual information because of having no necessity of inputting (entering) the address and the name as done in application for the reward through a postcard and a Web page.

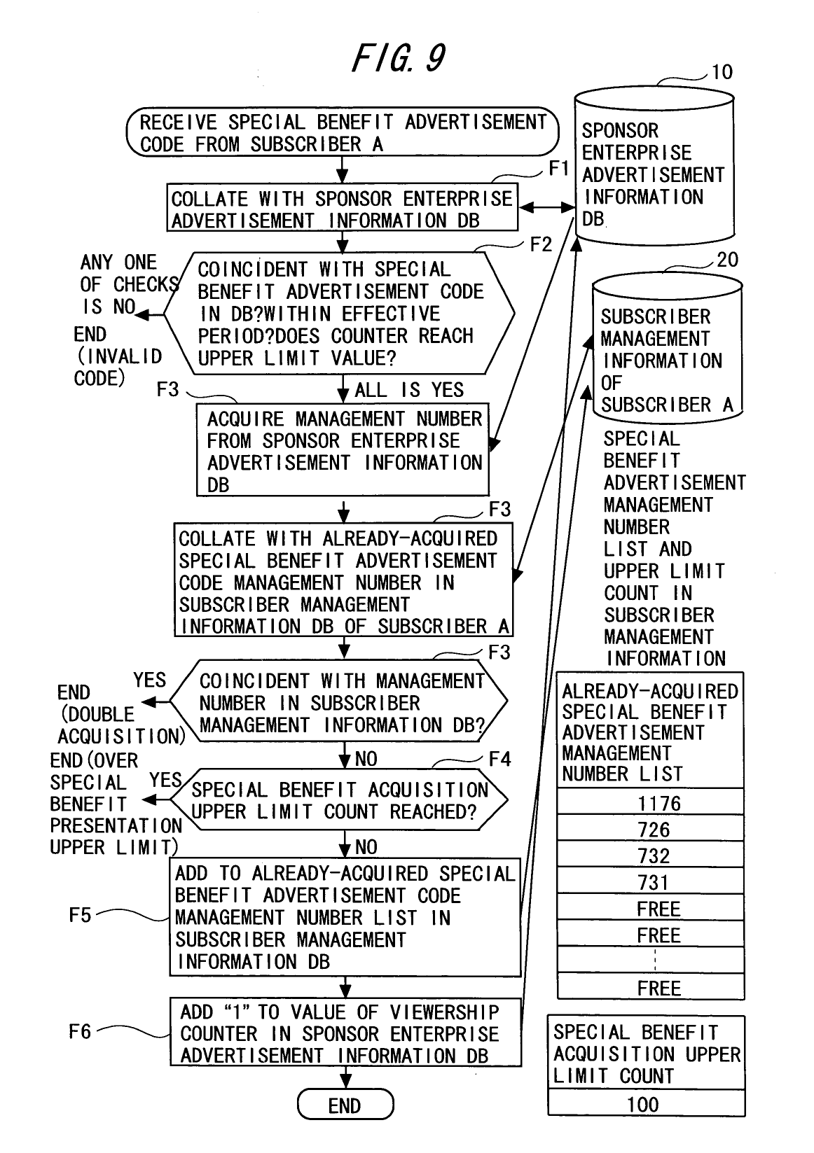

F: Reception and Collation of Special Benefit QR-CD Information (see FIG. 9)

The mobile phone network operator (the control device CPU), if the short message received from the user (the user terminal MT) is the special benefit advertisement code information, judges the validity thereof in the following manner, and adds the user's discount point. The control device CPU of the exchange EX executes this process by linking up with the subscriber management information database 20 and with the sponsor enterprise advertisement information DB 10.

[F1] The control device CPU searches the sponsor enterprise advertisement information DB 10 shown in FIG. 5 for the special benefit advertisement code received from the user terminal MT.

8 F2] If the received special benefit advertisement code is not coincident with the special benefit advertisement code in the sponsor enterprise advertisement information DB 10, if the effective period expires, or if the counter reaches its upper limit value, the special benefit advertisement code is judged to be invalid, and the process is terminated.

[F3] Whereas if coincident, an associated special benefit advertisement management number is acquired from the sponsor enterprise advertisement information DB 10, and an already-acquired special benefit advertisement management list related to the user (subscriber) concerned is retrieved from within the subscriber management information DB 20. If the acquired special benefit advertisement management number is coincident with the content in the already-acquired special benefit advertisement management number list, this acquisition is judged to be the double acquisition, and the process is terminated.

[F4] Further, whereas if the acquired special benefit advertisement management number is coincident with the content in the already-acquired special benefit advertisement management number list, it is judged by referring to a [special benefit acquisition upper limit count] in the subscriber management information database 20 whether or not a numerical value of the already-acquired special benefit advertisement management number is over the upper limit value. If over the upper limit value, the process is terminated. Moreover, a start and a stop of utilizing the advertisement providing service can be controlled by setting this special benefit acquisition upper limit count to [0].

[F5] As a result of the process in the item [F4] given above, if the subscriber can acquire the special benefit, the special benefit advertisement management number of the special benefit advertisement code of this time is added to the already-acquired special benefit advertisement management number list.

[F6] The control device CPU adds “1” to the value of the viewership count (counter) associated with the special benefit advertisement code of this time in the sponsor enterprise advertisement information DB 10, and terminates the process.

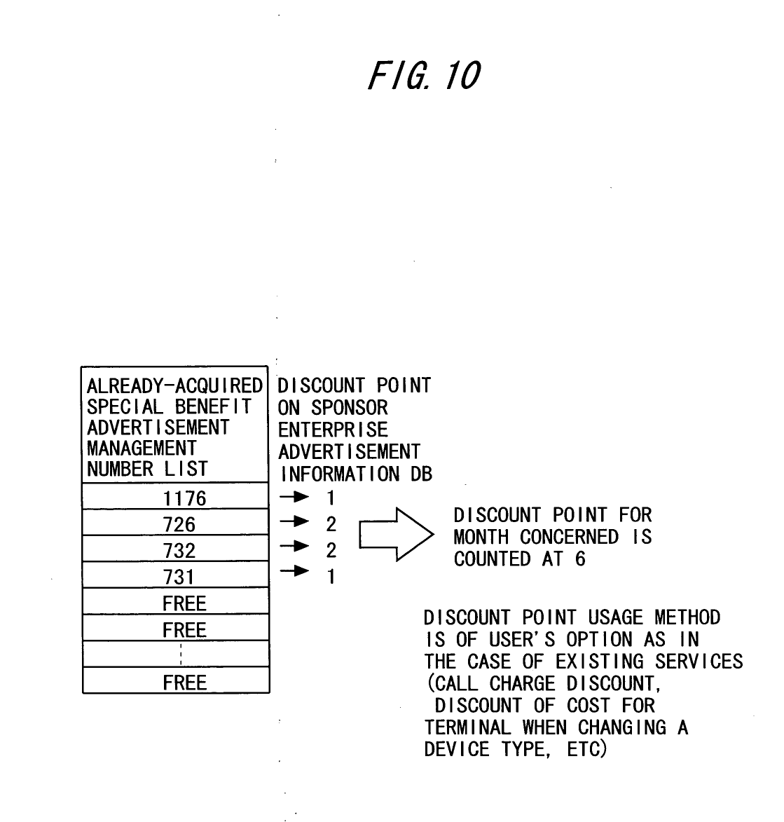

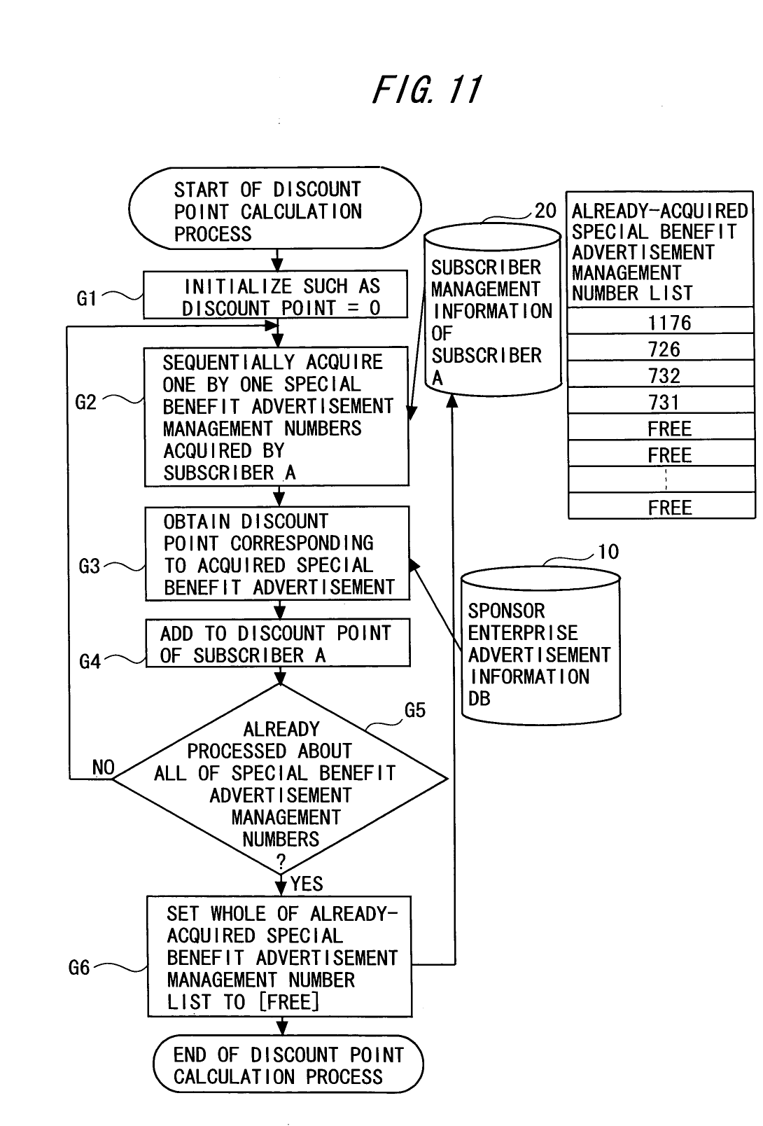

G: Calculation of Discount Point (see FIGS. 10 and 11)

The mobile phone network operator (the control device CPU), on the occasion of clearing up the call charge per month, adds up the discount points for the respective special benefit advertisements on the basis of the already-acquired special benefit advertisement management number list in the subscriber management information of the user (subscriber) A in the subscriber management information DB 20 and on the basis of the sponsor enterprise advertisement information DB 10, and sets the added-up points as the discount points to be acquired by the user in the month concerned. After calculating the discount points, the already-acquired special benefit advertisement management number list given on the user-by-user basis is all cleared (null state) . Procedures of this discount point calculation process are shown by G1-G6 in FIG. 11.

It is to be noted that the discount point shall be utilized for a discount of the call charge, a discount of cost for the terminal when changing the type of device and so on according to the user's intention as in the case of the existing services. Further, the discount points acquired by the user shall be referable to any time through a Web page for checking the usage charge, which is provided by the mobile phone network operator. Moreover, the user is notified of a discount point acquisition state that is also specified in a detailed statement of the charge per month.

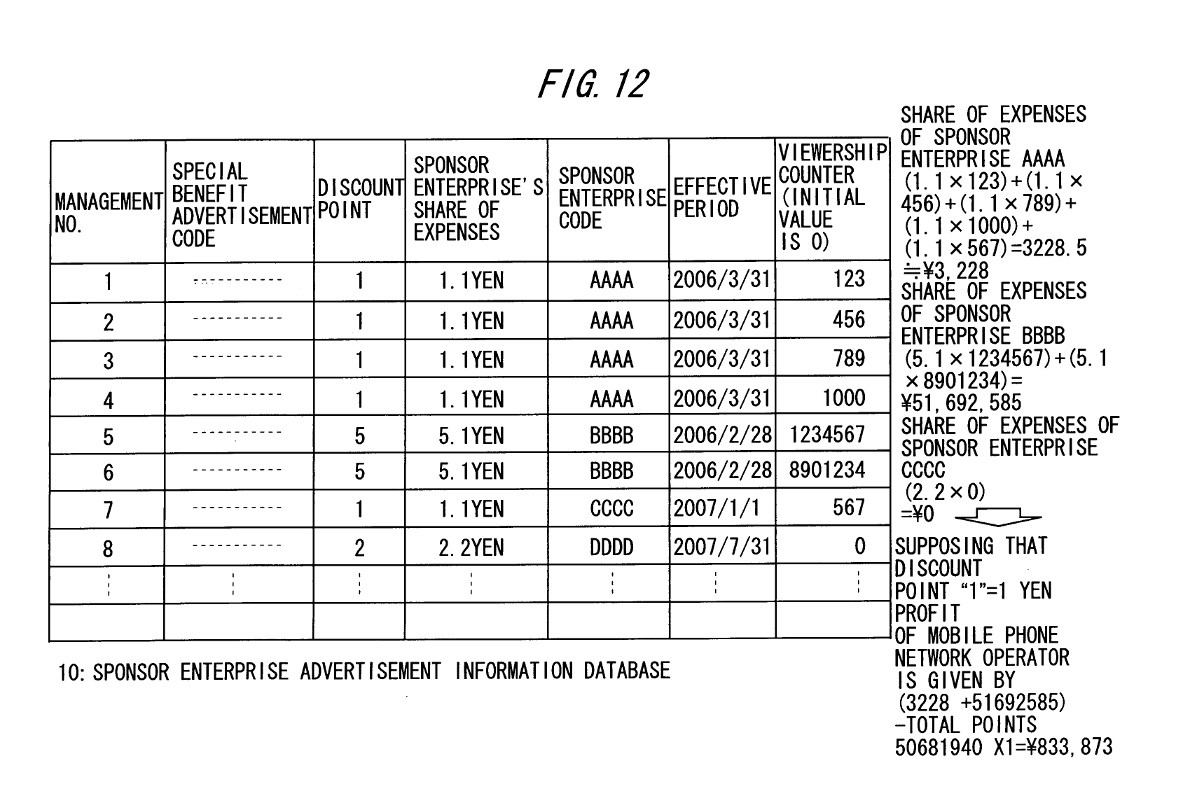

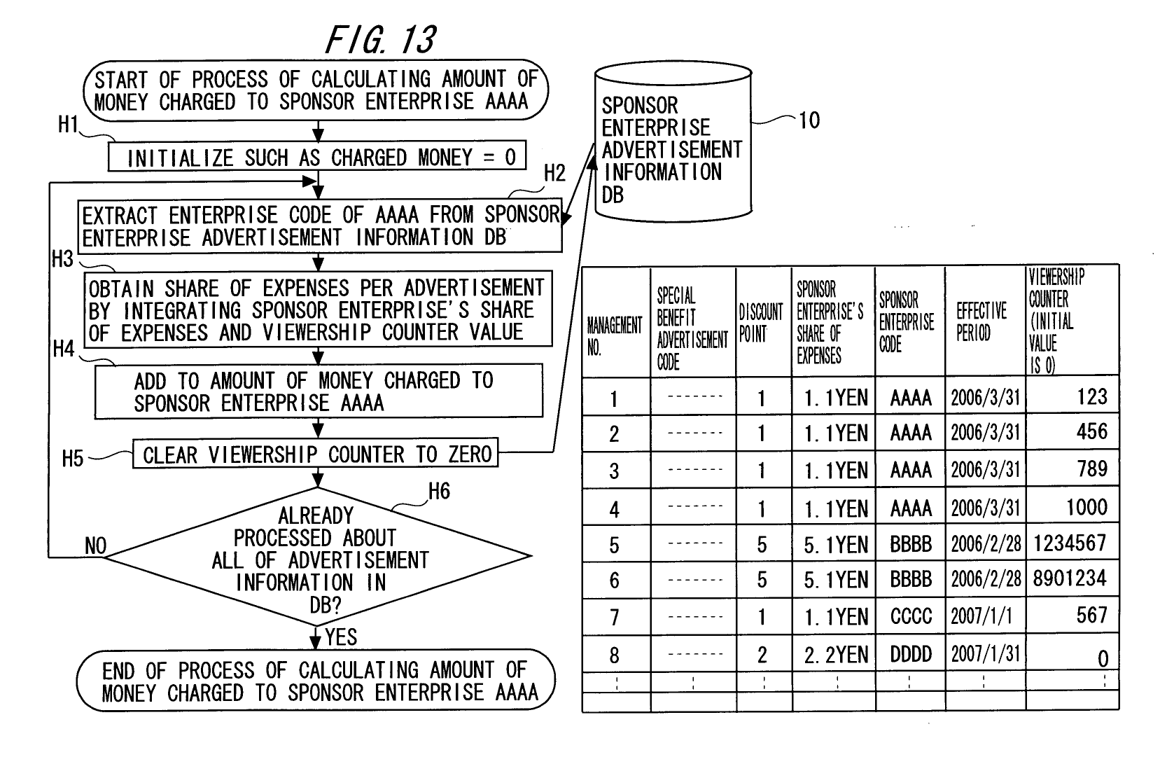

H: Transfer and Receipt of Service Usage Charge from Sponsor Enterprise to Mobile Phone Network Operator (see FIGS. 12 and 13)

The mobile phone network operator (control device CPU) refers to the sponsor enterprise advertisement information DB 10, thereby determining an amount of money (a sponsor enterprise's share of expenses) charged to each sponsor enterprise. In the case of the examples shown in FIGS. 12 and 13, a share of expenses of the sponsor enterprise AAAA is ¥3,228, a share of expenses of the sponsor enterprise BBBB is ¥51,692,585, and a share of expenses of the sponsor enterprise CCCC is ¥0 (namely, the value of the viewership counter becomes 0 because of the special benefit QR-CD attached advertisement being not yet released). Note that the already-cleared-off amount of money is subtracted from an amount of collection from the next time onward (which is not reflected). Procedures of a process of calculating an amount of money charged to the sponsor enterprise are shown by H1-H6 in FIG. 13.

On the other hand, a profit of the mobile phone network operator is the remainder obtained by subtracting an amount of money equivalent to the sum of the discount points from a total of the amount of money collected from these sponsor enterprises. In this example, supposing that one point of the discount points is equivalent to 1 yen, the profit of the mobile phone network operator becomes ¥833, 873.

### Modified Example

The advertisement providing service control system SYS in one embodiment discussed above has involved utilizing the QR code (registered trademark) defined as a kind of matrix system of the two-dimensional code, however, if having the information in two, lengthwise and crosswise, directions and if large of quantity of the recordable information, it is also possible to utilize a stacked bar code system such as PDF417 defined as one other type of two-dimensional code or other matrix systems such as Data Matrix and Maxi Code.

The processes in one embodiment discussed above are provided by way of a program executable by a computer, and can be provided through a recording medium such as a CD-ROM and a flexible disc and further via the communication line. Moreover, the respective processes in one embodiment discussed above can be executed in a way that selects and combines an arbitrary plurality of the processes or all the processes.

Others

The disclosure of Japanese Patent Application No. JP2006-062546 filed on Mar. 8, 2006 including the specification, claims, drawings and abstract is incorporated herein by reference in its entirety.

What is claimed is:

1. An advertisement providing service control device operated by a mobile carrier, comprising:
means receiving, from a mobile communication terminal utilized by a user, an encrypted advertisement code corresponding to two-dimensional code acquired from a two-dimensional code attached advertisement provided by a sponsor enterprise;
means judging validity of the received encrypted advertisement code by collating with storage information; and
means calculating, when the encrypted advertisement code is valid, an amount of money equivalent to a discount for the user in accordance with an advertisement acquisition count, and calculating a service fee for the sponsor enterprise.

2. An advertisement providing service control device according to claim 1, wherein the encrypted advertisement code contains sponsor enterprise identification information, advertisement commercial article identification information and advertising medium identification information in a copy-disabled mode.

3. An advertisement providing service control device according to claim 2, wherein the encrypted advertisement code further contains serial number information for every advertising medium in the copy-disabled mode.

4. An advertisement providing service control device according to claim 1, wherein the advertisement is at least one of a visible broadcasting advertisement, a visible distribution advertisement and a paper advertisement.

5. An advertisement providing service control device according to claim 1, wherein the two-dimensional code is of any one of a matrix system and a stacked bar code system.

6. An advertisement providing service control device according to claim 1, further comprising means providing the mobile communication terminal with software for reading and transmitting the two-dimensional code in response to a download request.

7. An advertisement providing service control method in a control device operated by a mobile carrier, comprising:
making receiving means receive, from a mobile communication terminal utilized by a user, an encrypted advertisement code corresponding to two-dimensional code acquired from a two-dimensional code attached advertisement provided by a sponsor enterprise;
making judging means judge validity of the received encrypted advertisement code by collating with storage information; and
making calculating means calculate, when the encrypted advertisement code is valid, an amount of money equivalent to a discount for the user in accordance with an advertisement acquisition count, and calculate a service fee for the sponsor enterprise.

8. An advertisement providing service control method according to claim 7, wherein the encrypted advertisement code contains sponsor enterprise identification information, advertisement commercial article identification information and advertising medium identification information in a copy-disabled mode.

9. An advertisement providing service control method according to claim 8, wherein the encrypted advertisement code further contains serial number information for every advertising medium in the copy-disabled mode.

10. An advertisement providing service control method according to claim 7, wherein the advertisement is at least one of a visible broadcasting advertisement, a visible distribution advertisement and a paper advertisement.

11. An advertisement providing service control method according to claim 7, wherein the two-dimensional code is of any one of a matrix system and a stacked bar code system.

12. An advertisement providing service control method according to claim 7, further making providing means provide the mobile communication terminal with software for reading and transmitting the two-dimensional code in response to a download request.

13. A readable medium recorded with a program making a control device operated by a mobile carrier, execute:
receiving, from a mobile communication terminal utilized by a user, an encrypted advertisement code corresponding to two-dimensional code acquired from a two-dimensional code attached advertisement provided by a sponsor enterprise;
judging validity of the received encrypted advertisement code by collating with storage information; and
calculating, when the encrypted advertisement code is valid, an amount of money equivalent to a discount for the user in accordance with an advertisement acquisition count, and calculating a service fee for the sponsor enterprise.
